(19) United States
(12) Patent Application Publication
(10) Pub. No.: US 2026/0081700 A1
(43) Pub. Date: Mar. 19, 2026

(54) LOOPBACK TESTING WITH TRANSMIT SIGNAL CROSS-OVER

(71) Applicant: QUALCOMM Incorporated, San Diego, CA (US)

(72) Inventors: Muhammad HASSAN, San Diego, CA (US); Chinmaya MISHRA, San Diego, CA (US)

(21) Appl. No.: 18/886,053

(22) Filed: Sep. 16, 2024

(51) Int. Cl. H04B 17/00; H04B 1/00; H04B 1/04; H04B 17/10; H04B 17/11

(52) U.S. Cl. CPC H04B 17/0085; H04B 1/0096; H04B 1/0483; H04B 17/104; H04B 17/11

(57) ABSTRACT

A method for use in self-testing a transceiver integrated circuit includes: receiving a test signal, having a first intermediate frequency, at a first intermediate frequency input/output port associated with a first transceiver subcircuit of the transceiver integrated circuit; directing the test signal to a second transceiver subcircuit of the transceiver integrated circuit; upconverting the test signal to have a radio frequency; amplifying the test signal by a power amplifier, of the second transceiver subcircuit, to provide an amplified test signal; coupling at least a portion of the amplified test signal as a feedback signal; downconverting the feedback signal to a second intermediate frequency; and directing the feedback signal to a second intermediate frequency input/output port associated with the second transceiver subcircuit.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi®, BLUETOOTH® and other short-range wireless communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5^{th} generation (5G) of wireless communication technology, mmW (millimeter-wave) phased-array antennas have received extensive attention to address the propagation loss and aperture blockage hurdles by introducing higher antenna gain and beamforming features. Multiple-input-multiple-output (MIMO) systems is one of the key enablers of 5G technology to increase the spectral efficiency and system capacity by effectively streaming the transmit/receive data with two orthogonally polarized signals (cross-polarized signals) in desired directions. The trend in consumer electronics is to develop RF (Radio Frequency) assemblies (radio frequency assemblies) with small form factors which can be easily accommodated within the limited space of the emerging smart devices including cell phones and tablets. The physical requirements of antennas make maintaining or improving performance (e.g., in terms of coverage, latency, and quality of service over desired coverage area) difficult.

Production of wireless communication devices, including millimeter-wave integrated circuit (IC) production, is costly in terms of test procedures, equipment, and testing time, and may be impractical to perform after manufacture, e.g., during mission operation. On-chip built-in self-test (BIST) circuitry may reduce cost, including testing time, but presents challenges to enable accurate test results.

### SUMMARY

An example transceiver integrated circuit includes: a first intermediate frequency input/output port; a second intermediate frequency input/output port; a first transceiver subcircuit including: a plurality of first radio frequency input/output ports; and a plurality of first power amplifiers each including a respective first power-amplifier output that is communicatively coupled to a respective one of the first radio frequency input/output ports; first routing circuitry that is responsive to at least one first routing control signal to communicatively couple the first intermediate frequency input/output port to the first transceiver subcircuit; a second transceiver subcircuit including: a plurality of second radio frequency input/output ports; and a plurality of second power amplifiers each including a respective second power-amplifier output that is selectively communicatively coupled to a respective one of the second radio frequency input/output ports; second routing circuitry that is responsive to at least one second routing control signal to communicatively couple the second intermediate frequency input/output port to the second transceiver subcircuit; and cross-over circuitry that is responsive to at least one first feedback control signal to communicatively couple the first intermediate frequency input/output port to the second routing circuitry to provide a first transmit signal from the first intermediate frequency input/output port to the second transceiver subcircuit.

An example method for use in self-testing a transceiver integrated circuit includes: receiving a test signal, having a first intermediate frequency, at a first intermediate frequency input/output port associated with a first transceiver subcircuit of the transceiver integrated circuit; directing the test signal to a second transceiver subcircuit of the transceiver integrated circuit; upconverting the test signal to have a radio frequency; amplifying the test signal by a power amplifier, of the second transceiver subcircuit, to provide an amplified test signal; coupling at least a portion of the amplified test signal as a feedback signal; downconverting the feedback signal to a second intermediate frequency; and directing the feedback signal to a second intermediate frequency input/output port associated with the second transceiver subcircuit.

Another example transceiver integrated circuit includes: means for receiving a test signal, having a first intermediate frequency, at a first intermediate frequency input/output port associated with a first transceiver subcircuit of the transceiver integrated circuit; means for directing the test signal to a second transceiver subcircuit of the transceiver integrated circuit; means for upconverting the test signal to have a radio frequency; means for amplifying the test signal to provide an amplified test signal; means for coupling at least a portion of the amplified test signal as a feedback signal; means for downconverting the feedback signal to a second intermediate frequency; and means for directing the feedback signal to a second intermediate frequency input/output port associated with the second transceiver subcircuit.

Another example transceiver integrated circuit includes: a first intermediate frequency input/output port; a second intermediate frequency input/output port; a first transceiver subcircuit including: a plurality of first radio frequency input/output ports; a plurality of first power amplifiers each including a respective first power-amplifier output that is communicatively coupled to a respective one of the plurality of first radio frequency input/output ports; and a plurality of first low-noise amplifiers each including a respective low-noise-amplifier input that is selectively communicatively coupled to a respective one of the plurality of first radio frequency input/output ports; first routing circuitry that is responsive to at least one first routing control signal to communicatively couple the first intermediate frequency input/output port to the first transceiver subcircuit; a mission-mode mixer at least selectively communicatively coupled to outputs of the plurality of first low-noise amplifiers via the first routing circuitry; a second transceiver subcircuit including: a plurality of second radio frequency input/output ports; and a plurality of second power amplifiers each including a respective second power-amplifier output that is communicatively coupled to a respective one of the plurality of second radio frequency input/output ports; second routing circuitry that is responsive to at least one second routing control signal to communicatively couple the second intermediate frequency input/output port to the second transceiver subcircuit; and feedback circuitry that is responsive to at least one feedback control signal to communicatively couple at least one respective first power-amplifier output of the plurality of first power amplifiers to the mission-mode mixer.

### BRIEF DESCRIPTION OF THE DRAWINGS

FIG. 1 is a schematic diagram of a communication system.

FIG. 2 is a block diagram of a user equipment including a transceiver.

FIG. 3 is a block diagram of an example of the user equipment shown in FIG. 2.

FIG. 4 is an example of a transceiver shown in FIG. 3.

FIG. 5 is a portion of an example of the transceiver shown in FIG. 4.

FIG. 6 is another example of the transceiver shown in FIG. 3.

FIG. 7 is a portion of an example of the transceiver shown in FIG. 6.

FIG. 8 is block flow diagram of an example method for use in self-testing a transceiver integrated circuit.

### DETAILED DESCRIPTION

Techniques are discussed herein for built-in self-test of an integrated circuit, e.g., a millimeter-wave transceiver integrated circuit (IC). For example, for a test mode, a transmission line for carrying an intermediate frequency transmit signal of one portion of a transceiver (e.g., a portion for providing a signal for one polarization) may be selectively connected to another transmission line for carrying an intermediate frequency transmit signal of another portion of the transceiver (e.g., a portion for providing a signal for another polarization). The transmission lines of the different portions of the transceiver may be disposed close to each other and may not have any components between them (or at least not transmission lines between them), e.g., such that a connection of a first one of the transmission lines to a second one of the transmission lines may not cross any other transmission lines, or may cross a single other transmission line (e.g., a transmission line for connecting the second transmission line to the first transmission line). In some example configurations, a mission mode mixer may be re-used, being used for both down-converting received mission-mode signals and down-converting feedback (test) signals. In some example configurations, a multiple-input, multiple-output mixer may be used for both down-converting received mission-mode signals and down-converting feedback (test) signals, with a mission-mode mixer being used only for down-converting mission-mode signals. Other configurations, however, may be used.

Items and/or techniques described herein may provide one or more of the following capabilities, and possibly one or more other capabilities not mentioned. An integrated circuit (IC) substrate may have a self-test function and thus performance of the IC substrate may be self-tested and production cost (e.g., testing time) may be reduced, e.g., without using external equipment. Self-test and calibration (e.g., digital pre-distortion calibration) may be performed on a transceiver IC after production, e.g., in the field. Intermediate frequency ports/cables may be used to enable real-time feedback of transmit signals for additional processing (e.g., digital pre-distortion and antenna impedance measurements/tuning). An output of each power amplifier supporting a phased-array antenna may be sampled one at a time during manufacture (in a calibration mode) or in a mission mode after manufacture. Outputs of power amplifiers in large arrays, possibly in multiple integrated circuits, may be sampled and the choice of power amplifier to be sampled may be based on information from other detectors associated with individual power amplifier elements. A time division duplex (TDD) system may be tested by transferring a test signal received at one input/output port to circuitry corresponding to another input/output port, and feeding back the test signal to the other input/output port. A TDD system may have a cross-layer loopback of a test signal with a simple (uncomplex) crossover of a test signal from one layer of the TDD system to another layer of the TDD system. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

The discussion herein focuses on communication systems, and in particular mmW (millimeter-wave) communication systems. The techniques discussed herein, however, may be used for other applications, for example systems which are configured for operation at higher (e.g., sub-THz) or lower (e.g., Frequency Range 3 (FR3)) frequencies.

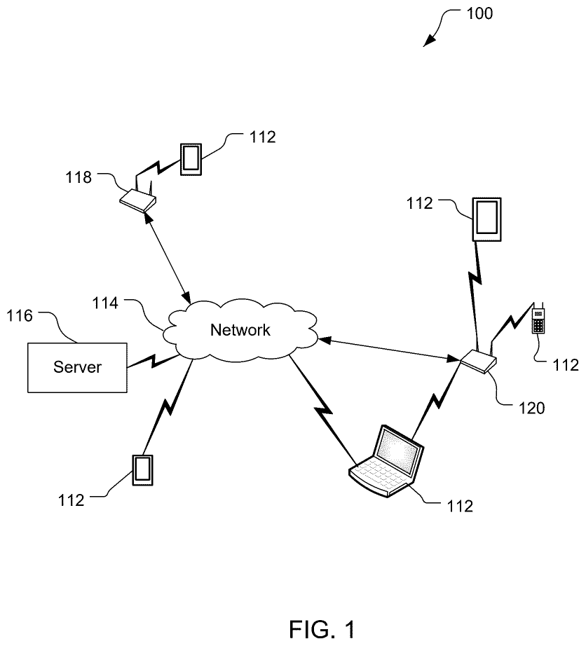

Referring to FIG. 1, a communication system 100 includes mobile devices 112, a network 114, a server 116, and access points (APs) 118, 120. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, the network 114, the server 116, and/or the APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi® communication, multiple frequencies of Wi-Fi® communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.). Each of the mobile devices 112 may be referred to as a user equipment (UE).

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

Further, two or more UEs may communicate directly in some configurations with or without passing information to each other through a network.

User equipment may be configured with one or more phased-array antenna systems that use Digital Pre-Distortion (DPD) to improve performance. A phased-array antenna system may include multiple phase shifters and corresponding power amplifiers to provide a transmit signal to different antenna elements with different phase shifts to direct an antenna beam in a desired direction. Digital Pre-Distortion may be used to compensate for non-linearity of the power amplifiers and DPD calibration may be performed to help ensure that proper DPD is applied when the antenna system is in use. DPD calibration may be performed during manufacture of a UE using over-the-air (OTA) loopback signals. While it is desired to capture a transmit signal at the highest available level (as that is where power amplifier linearity is typically best), due to strong mutual coupling between antenna elements, a receive chain may be desensitized due to the limit of acceptable signal power level in the receive chain. Using low receive chain gain states may not be acceptable because a signal traveling through the receive chain degrades linearity and may add noise in excess of the attenuation of the receive chain. Consequently, loopback testing through mutual coupling depends on the UE configuration, e.g., the amount of mutual coupling between antenna elements and the attenuation of the receive chain. Over-the-air loopback testing may result in large variations across frequencies and components, suggesting that mutual coupling calibration be performed prior to DPD training. Mutual coupling calibration, however, may undesirably increase factory calibration time and cost. Further, housing effects may result in incorrect calibration.

Techniques discussed herein may improve DPD calibration, e.g., by avoiding mutual coupling calibration avoiding OTA loopback calibration. For example, an internal (non-OTA) signal loopback (feedback) may be used for DPD and/or other applications, e.g., antenna impedance detection for antenna tuner control. Techniques are discussed herein for using an internal loopback of a transmit signal taken from the output of a power amplifier as part of a phased-array antenna system. Techniques discussed herein (e.g., internal signal loopback) may facilitate or even enable online calibration which may facilitate large-array DPD calibration.

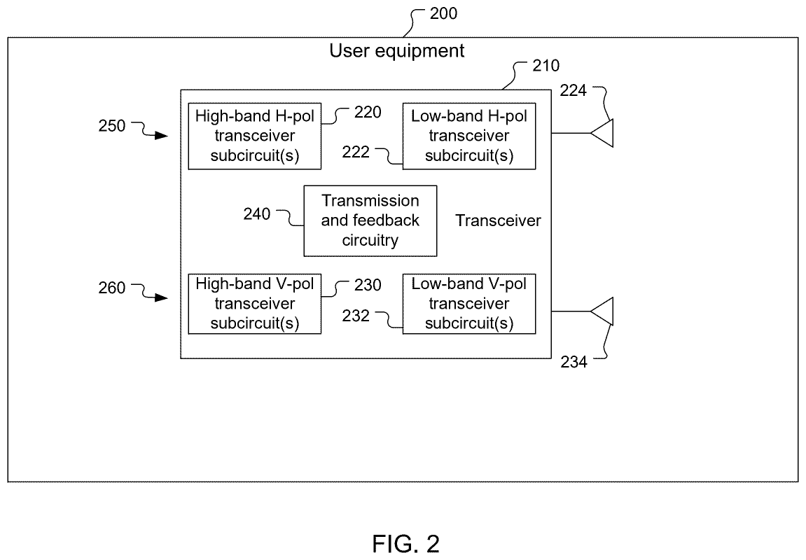

Referring to FIG. 2, a UE 200 (e.g., an example of the mobile devices 112) includes a transceiver 210. The transceiver 210 comprises more than one transceiver subcircuit, here transceiver subcircuits 220, 222, 230, 232, with different subcircuits configured to transmit and receive respective signals, e.g., of different frequencies and different polarizations. For example, the transceiver subcircuit(s) 220 may be configured for sending and/or receiving high-band horizontal-polarization signals (as sent and received by a horizontally-polarized antenna 224). The transceiver subcircuit(s) 222 may be configured for sending and/or receiving low-band horizontal-polarization signals (as sent and received by the horizontally-polarized antenna 224).

The transceiver subcircuit(s) 230 may be configured for sending and/or receiving high-band vertical-polarization signals (as sent and received by a vertically-polarized antenna 234). The transceiver subcircuit(s) 232 may be configured for sending and/or receiving low-band vertical-polarization signals (as sent and received by the vertically-polarized antenna 234). The antennas 224, 234 may be communicatively coupled to respective transceiver subcircuits and may be implemented as a single antenna with dual polarization. Further, separate antennas may be used for low-band and high-band signals. The low-band signals are in a “low” frequency band that is lower than a “high” frequency band of the high-band signals. The low band and high band may, for example, comprise a low mmW band (e.g., 24 GHz -29.5GHz) and a high mmW band (e.g., 37 GHz -43.5GHz), respectively. The transceiver 210 may include transmission and feedback circuitry 240 that is configured to direct transmit signals from one or more I/O ports to appropriate transmit circuitry (e.g., phase shifters, power amplifiers, and antenna elements) and to feed back one or more selected signals from one or more respective power amplifier outputs to the one or more I/O ports for measurement and analysis (e.g., externally to the transceiver 210 but within the UE 200). The subcircuits 220, 222, 230, 232 may be disposed in respective portions (e.g., quadrants) of the transceiver 210 as shown, e.g., respective quadrants of an integrated circuit comprising the transceiver 210.

The subcircuits 220, 222 may be parts of what is called a horizontal layer or “H-layer” 250 and the subcircuits 230, 232 may be parts of what is called a vertical layer or “V-layer” 260. The H-layer 250 comprises circuitry for processing (e.g., generating, amplifying, measuring, and/or decoding, etc.) signals corresponding to (e.g., to be transmitted with and/or signals received with) a first polarization. The V-layer 260 comprises circuitry for processing (e.g., generating, amplifying, measuring, and/or decoding, etc.) signals corresponding to a second polarization that is different from, e.g., orthogonal to, the first polarization. Types of polarization other than horizontal and vertical—for example, slant polarization, circular polarization, etc.—may be implemented.

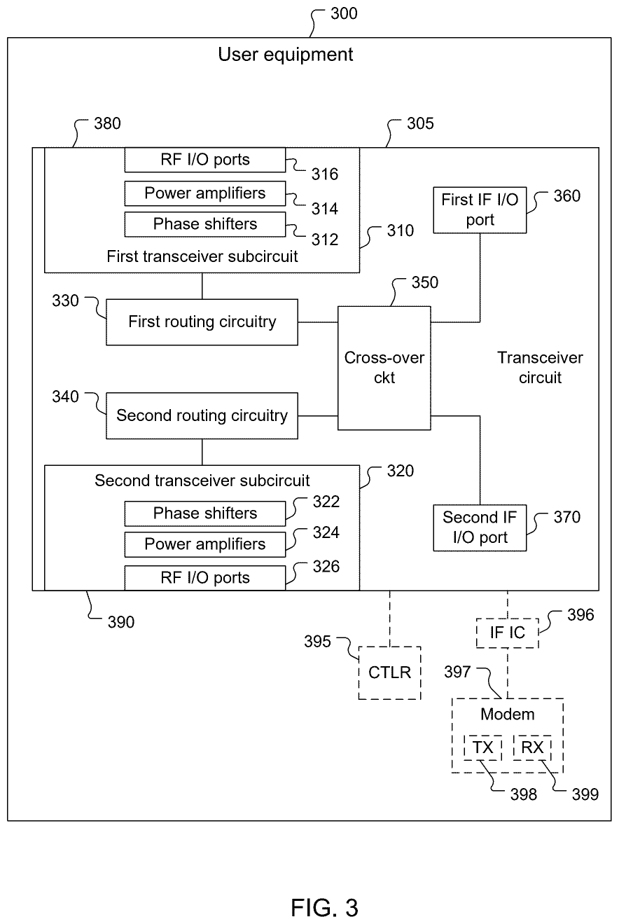

Referring to FIG. 3, an example UE 300 (e.g., an example of the UE 200) includes a transceiver 305 that includes a first transceiver subcircuit 310, a second transceiver subcircuit 320, first routing circuitry 330, second routing circuitry 340, a cross-over circuit 350, a first IF I/O port 360 (first intermediate frequency input/output port), and a second IF I/O port 370. The first transceiver subcircuit 310 may be, for example, a horizontal-polarization (H-pol) transceiver subcircuit such as an example of the subcircuit 220. The second transceiver subcircuit 320 may be, for example, a Vertical-polarization (V-pol) transceiver subcircuit such as an example of the subcircuit 230. The transceiver 305 may be an example of the transceiver 210 and may include other components not shown in FIG. 3, e.g., a low-band H-pol transceiver subcircuit (which may be coupled to the first IF I/O port 360 in some configurations) and a low-band V-pol transceiver subcircuit (which may be coupled to the second IF I/O port 370 in some configurations). The first transceiver subcircuit 310 includes phase shifters 312, power amplifiers 314, and RF I/O ports 316 (radio frequency input/output ports). The second transceiver subcircuit 320 includes phase shifters 322, power amplifiers 324, and RF I/O ports 326. The phase shifters 312, 322 may be communicatively coupled to the routing circuitry 330, 340, respectively, to receive respective transmit signals. Each of the phase shifters 312, 322 may be communicatively coupled to a respective input of a respective one of the power amplifiers 314, 324 to provide a respective transmit signal (as phase-shifted by the respective phase shifter 312, 322) to the respective power amplifier 314, 324. In other configurations, phase shifting is performed in an LO path instead of in a transmit signal path. Each of the power amplifiers 314, 324 may have an output communicatively coupled to a respective one of the RF I/O ports 316, 326 to provide a respective transmit signal (as amplified by the respective power amplifier 314, 324) to the respective RF I/O port 316, 326. The RF I/O ports 316, 326 may be disposed proximate to a respective side 380, 390 of the transceiver 305, e.g., at or near respective edges of an integrated circuit chip including the transceiver 305. The RF I/O ports 316 are disposed nearer to the side 380 of the transceiver 305 (e.g., an edge of a transceiver IC) than the power amplifiers 314. The first routing circuitry 330 is disposed further from the side 380 of the transceiver 305 than the power amplifiers 314. Similarly, the RF I/O ports 326 are disposed nearer to the side 390 of the transceiver 305 (e.g., an edge of a transceiver IC) than the power amplifiers 324 and the second routing circuitry 340 is disposed further from the side 390 of the transceiver 305 than the power amplifiers 324. The first routing circuitry 330 may be disposed adjacent to the second routing circuitry 340, e.g., with at least a portion (e.g., a transmission line) of the first routing circuitry 330 being adjacent to (e.g., less than 1 mm from and/or with no component between the first routing circuitry 330 and) at least a portion of the second routing circuitry 340. The first routing circuitry 330 may be closer to (e.g., in the same quadrant as) the first transceiver subcircuit 310 than to the second transceiver subcircuit 320. Similarly, the first routing circuitry 330 may be closer to the side 380 than the side 390. The first IF I/O port 360 may also be closer to the first transceiver subcircuit 310 than to the second transceiver subcircuit 320, and may be closer to the side 380 than the side 390. The second routing circuitry 340 may be closer to (e.g., in the same quadrant as) the second transceiver subcircuit 320 than to the first transceiver subcircuit 310. Similarly, the second routing circuitry 340 may be closer to the side 390 than the side 380. The second IF I/O port 370 may also be closer to the second transceiver subcircuit 320 than to the first transceiver subcircuit 310, and may be closer to the side 390 than the side 380. The first side 380 (e.g., a first edge of the transceiver 305) is separate from and substantially parallel to (e.g., within ±5° of parallel with) the second side 390 (e.g., a second edge of the transceiver 305).

The routing circuitry 330, 340 may communicatively couple the IF I/O ports 360, 370 to the transceiver subcircuits 310, 320, respectively. The routing circuitry 330 may respond to at least one control signal to communicatively couple the IF I/O port 360 to the first transceiver subcircuit 310, with the cross-over circuit 350 communicatively coupling the first IF I/O port 360 to the first routing circuitry 330. The routing circuitry 340 may respond to at least one control signal to communicatively couple the IF I/O port 370 to the second transceiver subcircuit 320, with the cross-over circuit 350 communicatively coupling the second IF I/O port 370 to the second routing circuitry 340. A controller 395 may be included in the UE 300 external to the transceiver 305 (or partially or completely internal to the transceiver 305) to provide the control signal(s) to the routing circuitry 330, 340.

The cross-over circuit 350 may selectively communicatively couple the IF I/O ports 360, 370 to the routing circuitry 330, 340. For example, the cross-over circuit 350 may respond to one or more control signals, e.g., from the controller 395, to selectively (e.g., using one or more switches) communicatively couple the first IF I/O port 360 to the first routing circuitry 330 or to the second routing circuitry 340. The cross-over circuit 350 may respond to one or more control signals, e.g., from the controller 395, to selectively (e.g., using one or more switches) communicatively couple the second IF I/O port 370 to the second routing circuitry 340 or to the first routing circuitry 330. For example, for a mission mode (a normal-operation mode), the cross-over circuit 350 may communicatively couple the first IF I/O port 360 to the first routing circuitry 330 and concurrently communicatively couple the second IF I/O port 370 to the second routing circuitry 340. For a first test mode, the cross-over circuit 350 may communicatively couple the second IF I/O port 370 to the first routing circuitry 330 to test transmission by the first transceiver subcircuit 310. For a second test mode, the cross-over circuit 350 may communicatively couple the first IF I/O port 360 to the second routing circuitry 340 to test transmission by the second transceiver subcircuit 320. The cross-over circuit 350 may couple closely separated points of transmission lines of the routing circuitry 330, 340.

The UE 300 may include an IF IC 396 and a modem 397 communicatively coupled to the transceiver 305. The modem 397 may comprise a transmit circuit 398 that provides a signal source, being configured to provide transmit signals to the I/O ports 360, 370. The modem 397 may comprise a receive circuit 399 configured to receive and process (e.g., measure and/or decode) signals received from the I/O ports 360, 370. The I/O ports 360, 370 may each comprise, for example, an electrically-conductive bump configured to be connected to the IF IC 396, or a transmission line connected to the IF IC 396. The controller 395 may be partially or wholly implemented within the modem 397 in some configurations.

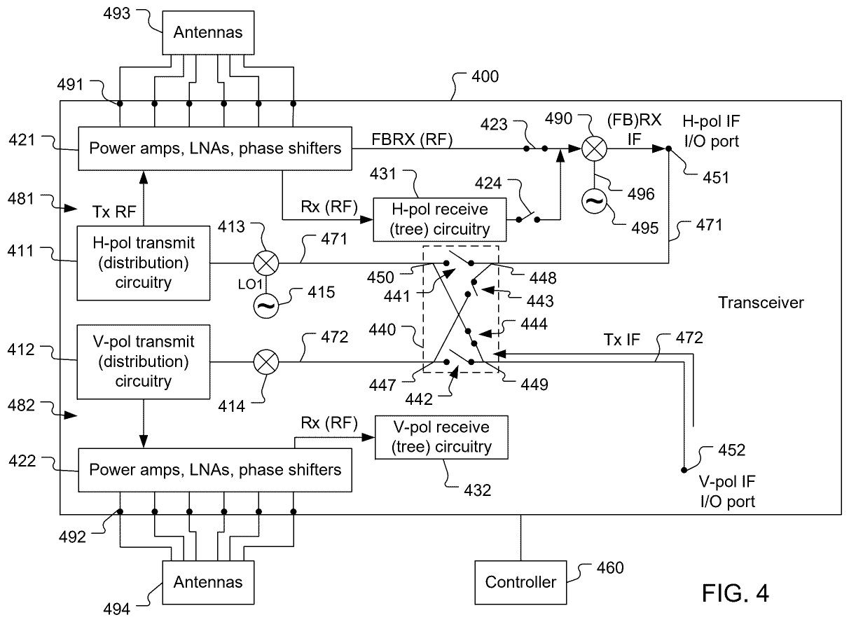

Referring also to FIG. 4, a transceiver 400, which is an example of the transceiver 305, includes H-pol transmit circuitry 411, V-pol transmit circuitry 412, an H-pol subcircuit 421, a V-pol subcircuit 422, H-pol receive circuitry 431, V-pol receive circuitry 432, a cross-over circuit 440, an H-pol IF I/O port 451, and a V-pol IF I/O port 452. The transceiver 400 may include other elements not shown. For example, the components shown in FIG. 4 may be for high-band use and components for low-band use are not shown. Further, many components are not shown in order to reduce the complexity of FIG. 4. For example, the selective connections of the V-pol subcircuit 422 and the V-pol receive circuitry 432 to the V-pol IF I/O port 452 are omitted from FIG. 4. As another example, only a single band (e.g., a high band) of H-pol and V-pol circuitry are shown, but the transceiver 400, being an example of the transceiver 305 (which is an example of the transceiver 210), may include another band (e.g., a low band) of H-pol and V-pol circuitry, e.g., the low-band H-pol transceiver subcircuit(s) 222 and the low-band V-pol transceiver subcircuit(s) 232. In the transceiver 400, a single (or common, when there are more than one) receive mixer may be provided for each layer (e.g., each polarization and potentially for each frequency band) and used for both feedback and mission signal reception (e.g., communication signal reception, data signal reception, positioning signal reception, etc.).

The cross-over circuit 440 includes switches 441, 442, 443, 444 (which may be called cross-over switches) that can selectively communicatively couple the IF I/O ports 451, 452 and the transmit circuitry 411, 412. The cross-over circuit 440 may be communicatively coupled to a controller 460 that may be disposed external to the transceiver 400 (as shown) or part of the transceiver 400. The cross-over circuit 440 may respond to control signals from the controller 460 to couple, during a mission mode, the H-pol IF I/O port 451 to the H-pol transmit circuitry 411 via a transmit mixer 413 by closing the switch 441 and opening the switch 443. Also or alternatively, the cross-over circuit 440 may respond to control signals from the controller 460 to couple, during the mission mode, the V-pol IF I/O port 452 to the V-pol transmit circuitry 412 via a transmit mixer 414 by closing the switch 442 and opening the switch 444. The cross-over circuit 440 may respond to control signals from the controller 460 to couple, during a first test mode, the V-pol IF I/O port 452 to the H-pol transmit circuitry 411 via the transmit mixer 413 by closing the switch 444 and opening the switches 441, 442, 443 (as shown in FIG. 4). The cross-over circuit 440 may respond to control signals from the controller 460 to couple, during a second test mode, the H-pol IF I/O port 451 to the V-pol transmit circuitry 412 via the transmit mixer 414 by closing the switch 443 and opening the switches 441, 442, 444. The cross-over circuit 440 crosses transmit IF transmission lines 471, 472 of an H-layer 481 and a V-layer 482 with the transmit IF transmission lines 471, 472 being disposed physically close to each other in the transceiver 400 (at least physically much closer to each other than power amplifier outputs of the subcircuits 421, 422). The cross-over circuit 440 may couple closely separated points of the transmission lines 471, 472. For example, the switch 444 of the cross-over circuit 440 may couple a point 449 of the transmit IF transmission line 472 with a point 450 of the transmit IF transmission line 471, with the points 449, 450 being separated by a short distance, e.g., less than 1 mm (e.g., less than 500 μm). The switches 443, 444 may be responsive to first and second control signals (which may be the same control signal) to communicatively couple respective points of the transmit IF transmission lines 471, 472, here points 447, 448 and the points 449, 450, respectively.

First RF I/O ports 491 corresponding to the H-pol subcircuit 421, and second RF I/O ports 492 corresponding to the V-pol subcircuit 422, are disposed at opposite sides of the transceiver 400, e.g., opposite edges of an IC containing the transceiver 400. The RF I/O ports 491, 492 may be coupled to respective polarization ports of respective antennas 493, 494. The antennas 493, 494 may be disposed, for example, on an integrated circuit chip that is separate from an IC chip containing the transceiver 400. The IC chip containing the transceiver 400 may be overlaid with the IC chip containing the antennas 493, 494. In other configurations, the antennas 493, 494 are the same antennas, e.g., a single antenna is configured to support multiple polarizations and is coupled to respective ports in both the RF I/O ports 491 and 492. Thus, feedback and/or receive circuitry may be provided in each of the layers 481, 482.

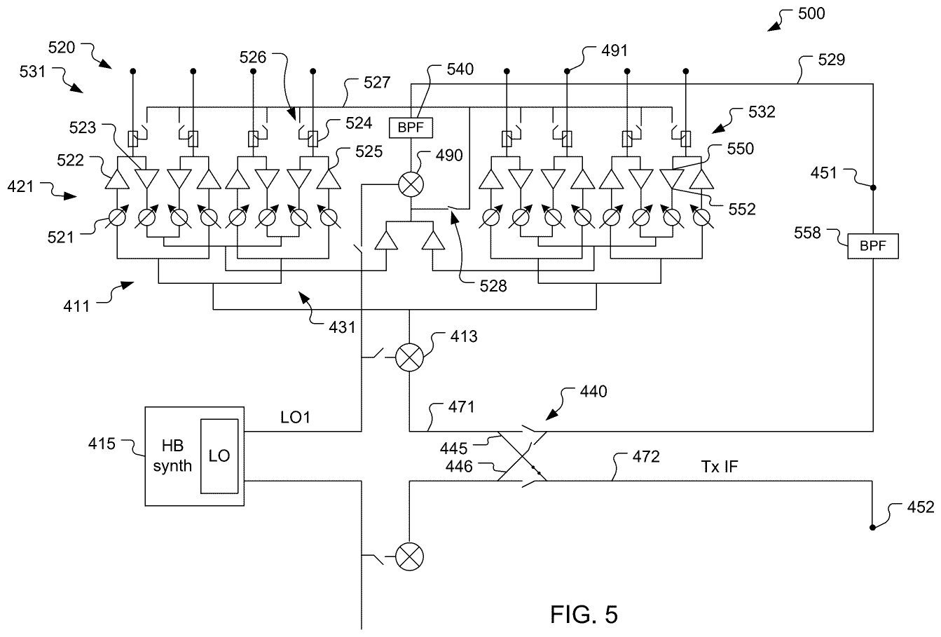

The cross-over circuit 440 may be disposed where circuitry for conveying a transmitting signal from the H-pol IF I/O port 451 to the H-pol transmit circuitry 411 is disposed close to circuitry for conveying a transmitting signal from the V-pol IF I/O port 452 to the V-pol transmit circuitry 412. Also or alternatively, the cross-over circuit 440 may be disposed where the cross-over circuit 440 can connect circuitry for conveying a transmitting signal from the H-pol IF I/O port 451 to the H-pol transmit circuitry 411 to circuitry for conveying a transmitting signal from the V-pol IF I/O port 452 to the V-pol transmit circuitry 412 without crossing any transmission lines outside of the cross-over circuit 440 (and crossing only a single transmission line, if any, in the cross-over circuit 440, in this example either a transmission line 445 (see FIG. 5) or a transmission line 446 (see FIG. 5)). By crossing between layers by connecting IF transmission lines, short cross-layer connections over few if any transmission lines may be provided such that complexity of testing circuity is kept simple (uncomplex) and signal loss in testing circuitry may be kept low, e.g., due to short connections between layers. Alternatively, the cross-over circuit 440 may be disposed where the cross-over circuit 440 can connect circuitry for conveying a transmitting signal from the H-pol IF I/O port 451 to the H-pol transmit circuitry 411 to circuitry for conveying a transmitting signal from the V-pol IF I/O port 452 to the V-pol transmit circuitry 412 while crossing fewer transmission lines than would be crossed by routing a signal from receive circuitry of one layer to receive circuitry of another layer.

The subcircuit 421 is coupled to the H-pol receive circuitry 431 and the subcircuit 421 may be selectively coupled to a mission-mode mixer 490 for a test mode and the H-pol receive circuitry 431 may be selectively coupled to the mission-mode mixer 490 in a mission mode (e.g., a normal operation mode, e.g., for receiving communication signals, data signals, and/or positioning signals, etc.). Switches 423, 424, responsive to one or more control signals from the controller 460, may selectively couple or isolate the subcircuit 421 and the H-pol receive circuitry 431 to/from the mission-mode mixer 490. The mission-mode mixer 490 can mix an RF receive signal (Rx) from the H-pol receive circuitry 431 or an RF feedback signal (FBRX signal) from the subcircuit 421 at radio frequency (e.g., at a millimeter-wave frequency) with an oscillator signal 496 from an oscillator 495 (e.g., an oscillator signal LO1 from an oscillator 415) to convert the RF receive signal or the FBRX signal from an RF frequency to an IF frequency. A receive mixer and FBRX connections (not illustrated in FIG. 4 for simplicity) may be implemented for the V-pol and coupled to the IF I/O port 452.

Referring also to FIG. 5, a transceiver 500, which is an example of the transceiver 400, is shown including details of the H-pol transmit circuitry 411, the H-pol subcircuit 421, and the H-pol receive circuitry 431. In particular, phase shifters 521, power amplifiers 522, and LNAs 523 (low-noise amplifiers) of the H-pol subcircuit 421 are shown, with the H-pol sub-circuit 421 including multiple (here two) sets 531, 532 of the phase shifters 521, the power amplifiers 522, and the LNAs 523. Further, feedback circuitry (e.g., in each transceiver subcircuit) may feed back a signal output by a power amplifier for testing. For example, feedback circuitry 520 includes couplers 524, switches 526, a feedback line 527, and a switch 528. Each of the couplers 524 couples a portion of a respective signal from a respective power amplifier output 525 to a respective one of the switches 526 that is responsive to a control signal from the controller 460 (not shown in FIG. 5) to selectively couple the respective coupler 524 to the feedback transmission line 527 that is selectively coupled through the switch 528 (e.g., the switch 423 shown in FIG. 4) to a mission-mode mixer, e.g., the mission-mode mixer 490. The feedback circuitry 520 is responsive to at least one feedback control signal (e.g., at least one control signal from the controller 395 (FIG. 3)) to communicatively couple at least one (e.g., one) of the power amplifier outputs 525 to the mission-mode mixer 490. The mission-mode mixer 490 may be used for down-conversion of received mission mode signals and down-conversion of feedback signals. Each of the LNAs 523 has an input 550 communicatively coupled to a respective one of the RF I/O ports 491 and an output 552 communicatively coupled to a respective one of the phase shifters 521. In other configurations, phase shifting is performed in an LO path instead of in a receive signal path The mission-mode mixer 490 is communicatively coupled (possibly selectively communicatively coupled via one or more switches) to the outputs 552 of the LNAs 523.

Feedback circuitry is shown for feeding back a (portion of a) high-band transmit signal and using the mission-mode mixer 490 and the oscillator 495 to reduce the feedback signal to IF for further processing, e.g., down-conversion to a baseband frequency and analysis, e.g., measurement, e.g., by the modem 397. In the examples shown in FIGS. 4 and 5, a mission-mode mixer may be used for down-converting an RF feedback signal to IF and providing the down-converted feedback signal to an IF I/O port, but other configurations may be used, e.g., with a MIMO mixer used for down-converting an RF feedback signal, as discussed further below.

During a test mode, a transmit signal is conveyed from an IF I/O port of one layer of the transceiver 400, through the cross-over circuit 440 to the other layer of the transceiver, through a mixer, and through transmit circuitry to phase shifters and power amplifiers, and a portion of an RF transmit signal is fed back through a mixer to the IF I/O port of the other layer of the transceiver 400. For example, as shown in FIGS. 4 and 5, a test signal Tx IF is provided to the V-pol IF I/O port 452. The test signal Tx IF has a frequency at an intermediate frequency. The test signal Tx IF is conveyed from the transmit IF transmission line 472 through the cross-over circuit 440, in particular the switch 444, to the transmit IF transmission line 471 to the transmit mixer 413. The transmit mixer 413, which may be called a transmission mixer, may be communicatively coupled to the oscillator 415 (e.g., a local oscillator), and selectively communicatively coupled to the I/O ports 451, 452 via the cross-over circuit 440. The transmit mixer 413 may be responsive to reception of the oscillator signal LO1 from the oscillator 415 and reception of the Tx IF signal (from the H-pol I/O port 451 or from the V-pol I/O port 452) to multiply the Tx IF signal by the oscillator signal LO1. The transmit mixer 413 may thus mix the intermediate-frequency test signal Tx IF with the oscillator signal from the oscillator 415 (which may be the oscillator 495, or may be different) to convert the test signal Tx IF to a radio-frequency test signal Tx RF at a radio frequency, e.g., at a millimeter-wave frequency. The transmit mixer 413 is communicatively coupled to phase shifters of the subcircuit 421 to provide the radio-frequency test signal Tx RF to the phase shifters of the subcircuit 421 through the H-pol transmit circuitry 411 (e.g., a distribution tree of transmission lines shown in FIG. 5) to split the radio-frequency test signal Tx RF into multiple RF test signals and to convey each respective RF test signal to a respective power amplifier (e.g., one of the power amplifiers 522) of the H-pol subcircuit 421. A portion of the output of one of the power amplifiers is used as the FBRX signal and provided through the feedback transmission line 527, the switch 423, the mission-mode mixer 490, and a transmission line 529 to the H-pol IF I/O port 451. For example, a selected one of the power amplifiers 522 is connected, by closure of a respective one of the switches 526, to the feedback transmission line 527, and the switch 528 is closed to provide the FBRX signal to the mission-mode mixer 490. The output of the mission-mode mixer 490 is provided to the H-pol IF I/O port 451. The output of the mission-mode mixer 490 may be coupled to the H-pol IF I/O port 451 via a BPF 540 (a band-pass filter) and the transmission line 529. The BPF 540 may pass signals (e.g., suppress signals less than a first threshold attenuation such as less than 0.5 dB attenuation) that are in an Rx IF frequency range (reception intermediate frequency range) and reject signals (e.g., suppress signals more than a second threshold attenuation such as more than 5 dB) that are outside of the Rx IF frequency range (e.g., by more than a first threshold frequency from the Rx IF frequency range). A BPF 558 may be provided between the H-pol IF I/O port 451 and the cross-over circuit 440 to pass signals in a Tx IF frequency range (transmission intermediate frequency band) and to reject signals outside of the Tx IF frequency range (e.g., by more than a second threshold frequency from the Tx IF frequency range). Frequencies in both the Rx IF frequency range and the Tx IF frequency range may be, for example, about ⅓ of the frequency of RF signals transmitted or received by the antennas 493.

Both of the layers 481, 482 may be used for transmission concurrently, of the same or different bands, while switches may ensure transmission by one of the bands (at most, in some configurations) in each of the layers 481, 482 at any given time. The switch 441 (for the horizontal layer 481) may direct an IF Tx signal from the H-pol IF I/O port 451 to the H-pol transmit circuitry 411 and the switch 442 (for the vertical layer 482) may direct an IF Tx signal from the V-pol IF I/O port 452 to the V-pol transmit circuitry 412. The frequency of the IF transmit signal and the frequency of the IF feedback signal (FBRX IF) may be the same.

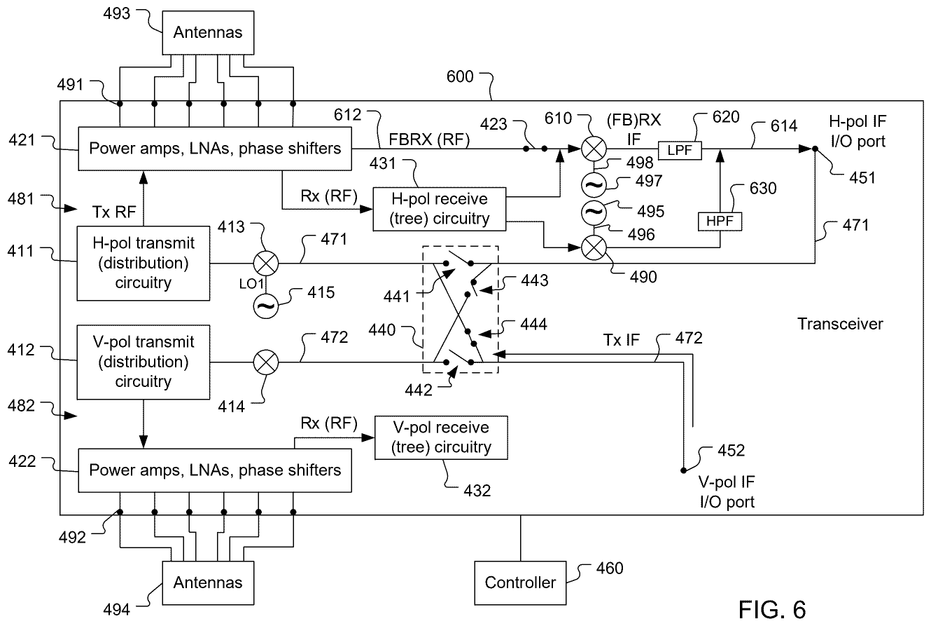

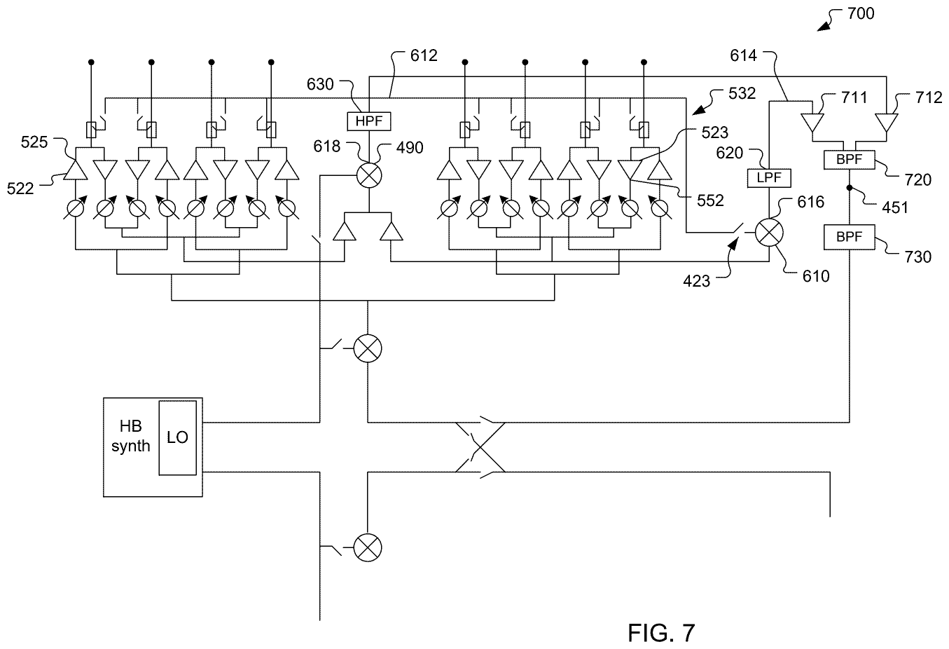

Referring to FIGS. 6 and 7, with further reference to FIGS. 3-5, a transceiver 600, which is an example of the transceiver 305, is similar to the transceiver 400 but includes an additional mixer 610 for down-converting the FBRX signal. The additional mixer 610 may be configured for MIMO operation and/or carrier aggregation operation, in some configurations, and will be referred to herein as MIMO mixer 610. The mixer 610 may be configured for operations other than MIMO. A transceiver 700 is an example of the transceiver 600, with some details shown.

The output 525 of a selected one of the power amplifiers 522 may be communicatively coupled to the MIMO mixer 610 via the switch 423 and a transmission line 612. The transceiver 600 does not include the switch 424 in some configurations, such that at least a portion of signals received by the subcircuit 421 are provided to the MIMO mixer 610. With the transceiver 600 configured to provide MIMO operation, the oscillator 495 may be used for the mission-mode mixer 490 and an oscillator 497 used for the MIMO mixer 610 to produce output signals of different intermediate frequencies from input signals of the same frequency. The MIMO mixer 610 is separate from the mission-mode mixer 490, may serve as a feedback mixer, and is communicatively coupled (possibly selectively communicatively coupled via one or more switches not shown) to at least a portion of the LNAs 523 (e.g., the LNAs 523 of the set 532). The MIMO mixer 610 may be coupled to the H-pol IF I/O port 451 via an LPF 620 (a low-pass filter) and a transmission line 614, and the mission-mode mixer 490 may be coupled to the H-pol IF I/O port 451 via an HPF 630 such that the feedback signal and a received signal may coexist at the H-pol IF I/O port 451. The MIMO mixer 610 may be used for both MIMO Rx and for feedback (loopback, e.g., testing). The LPF 620 may pass signals (e.g., suppress signals less than a first threshold attenuation such as less than 0.5 dB attenuation) that are below a first threshold frequency and reject signals (e.g., suppress signals more than a second threshold attenuation such as more than 5 dB) that are above a second threshold frequency. The HPF 630 may reject signals below a third threshold frequency and pass signals above a fourth threshold frequency. Examples of the first, second, third, and fourth threshold frequencies are 9 GHz, 10 GHz, 10 GHz, and 11 GHz, respectively, to help enable two receive signals that are approximately 2 GHz apart be combined and down-converted concurrently. Amplifiers 711, 712 are communicatively coupled to the filters 620, 630, respectively, and configured to amplify signals from the filters 620, 630 and to provide corresponding amplified signals to a BPF 720. A directional coupler (not shown) may couple the H-pol IF I/O port 451 to a BPF 730 and couple the BPF 720 to the H-pol IF I/O port 451. The BPFs 720, 730 are configured to pass signals of frequencies in respective pass bands and to reject signals of frequencies outside of the respective pass bands (e.g., by more than a threshold frequency). Passbands of the BPFs 720, 730 may pass Rx IF signals, FBRX IF signals, and Tx IF signals.

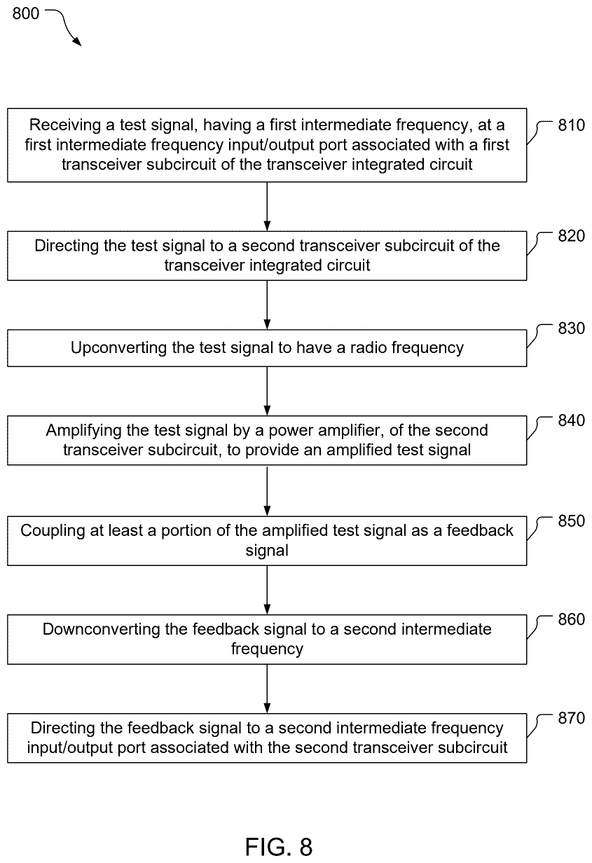

Referring to FIG. 8, with further reference to FIGS. 1-7, a method 800 for use in self-testing a transceiver integrated circuit includes the stages shown. The method 800 is, however, an example only and not limiting. The method 800 may be altered, e.g., by having one or more stages added, removed, rearranged, combined, performed concurrently, and/or by having one or more single stages split into multiple stages.

At stage 810, the method 800 includes receiving a test signal, having a first intermediate frequency, at a first intermediate frequency input/output port associated with a first transceiver subcircuit of the transceiver integrated circuit. For example, the test signal Tx IF may be received by the V-pol IF I/O port 452. The V-pol IF I/O port 452 may comprise means for receiving the test signal.

At stage 820, the method 800 includes directing the test signal to a second transceiver subcircuit of the transceiver integrated circuit. For example, the test signal Tx IF may be transmitted through the transmit IF transmission line 472, the switch 444, and the transmission line 445 to the transmit IF transmission line 471. The transmit IF transmission line 472, the switch 444, and the transmission line 445 may comprise means for directing the test signal to the second transceiver subcircuit.

At stage 830, the method 800 includes upconverting the test signal to have a radio frequency. For example, the test signal Tx IF may be upconverted by the transmit mixer 413 multiplying the test signal Tx IF by an oscillator signal from the oscillator 415 to produce the radio-frequency test signal Tx RF. The transmit mixer 413 and the oscillator 415 may comprise means for upconverting the test signal.

At stage 840, the method 800 includes amplifying the test signal by a power amplifier, of the second transceiver subcircuit, to provide an amplified test signal. For example, respective portions of the radio-frequency test signal Tx RF may be amplified by the power amplifiers 522 to produce amplified test signals. One of the power amplifiers 522 may comprise means for amplifying the test signal.

At stage 850, the method 800 includes coupling at least a portion of the amplified test signal as a feedback signal. For example, a respective one of the couplers 524 couples a portion of the amplified test signal as a feedback signal FBRX. The coupler 524 may comprise means for coupling at least a portion of the amplified test signal.

At stage 860, the method 800 includes downconverting the feedback signal to a second intermediate frequency. In some examples, the second intermediate frequency is the same as the first intermediate frequency. For example, the mission-mode mixer 490 may use the oscillator signal 496 from the oscillator 495 (e.g., the oscillator signal LO1 from the oscillator 415) to downconvert the feedback signal from radio frequency to intermediate frequency. As another example, the MIMO mixer 610 may use an oscillator signal 498 from the oscillator 497 to downconvert the feedback signal from radio frequency to a second intermediate frequency that is different from the first intermediate frequency. The oscillator 495, in combination with the mission-mode mixer 490, or the oscillator 497, in combination with the MIMO mixer 610, may comprise means for downconverting the feedback signal.

At stage 870, the method 800 includes directing the feedback signal to a second intermediate frequency input/output port associated with the second transceiver subcircuit. For example, the feedback signal FBRX may be directed to the H-pol IF I/O port 451 from the mission-mode mixer 490 by the transmission line 529, or from the MIMO mixer 610 by the transmission line 614. The transmission line 529 or the transmission line 614 may comprise means for directing the feedback signal to the second intermediate frequency input/output port.

Implementations of the method 800 may include one or more of the following features. In an example implementation, downcoverting the feedback signal comprises mixing the feedback signal with a local oscillator signal in a mission-mode mixer of the second transceiver subcircuit. In another example implementation, downcoverting the feedback signal comprises mixing the feedback signal with a local oscillator signal in a multi-input/multiple-output mixer of the second transceiver subcircuit, the multi-input/multiple-output mixer being separate from a mission-mode mixer of the second transceiver subcircuit. In a further example implementation, the method 800 further includes filtering the feedback signal output by the multi-input/multiple-output mixer using a first frequency-based filter to pass signals in a first frequency band and to reject signals in a second frequency band, wherein a second frequency-based filter is communicatively coupled to an output of the mission-mode mixer and is configured to reject signals in a third frequency band and to pass signals in a fourth frequency band. For example, the LPF 620 may be communicatively coupled to an output 616 of the MIMO mixer 610 and may pass signals below a first threshold frequency and reject signals above a second threshold frequency, and the HPF 630 may be communicatively coupled to an output 618 the mission-mode mixer 490 and may reject signals below a third threshold frequency (e.g., the first threshold frequency) and pass signals above a fourth threshold frequency (e.g., the second threshold frequency).

### Implementation Examples

Implementation examples are provided in the following numbered clauses.

Clause 1. A transceiver integrated circuit comprising:
a first intermediate frequency input/output port;
a second intermediate frequency input/output port;
a first transceiver subcircuit including:
   a plurality of first radio frequency input/output ports; and
   a plurality of first power amplifiers each including a respective first power-amplifier output that is communicatively coupled to a respective one of the plurality of first radio frequency input/output ports;
first routing circuitry that is responsive to at least one first routing control signal to communicatively couple the first intermediate frequency input/output port to the first transceiver subcircuit;
a second transceiver subcircuit including:
   a plurality of second radio frequency input/output ports; and
   a plurality of second power amplifiers each including a respective second power-amplifier output that is communicatively coupled to a respective one of the plurality of second radio frequency input/output ports;
second routing circuitry that is responsive to at least one second routing control signal to communicatively couple the second intermediate frequency input/output port to the second transceiver subcircuit; and
cross-over circuitry that is responsive to at least one first feedback control signal to communicatively couple the first intermediate frequency input/output port to the second routing circuitry to provide a first transmit signal from the first intermediate frequency input/output port to the second transceiver subcircuit.

Clause 2. The transceiver integrated circuit of clause 1, wherein:
the plurality of first radio frequency input/output ports are disposed nearer a first edge of the transceiver integrated circuit than the plurality of first power amplifiers;
the first routing circuitry is disposed further from the first edge of the transceiver integrated circuit than the plurality of first power amplifiers;
the plurality of second radio frequency input/output ports are disposed nearer a second edge of the transceiver integrated circuit than the plurality of second power amplifiers; and
the second routing circuitry is disposed further from the second edge of the transceiver integrated circuit than the plurality of second power amplifiers.

Clause 3. The transceiver integrated circuit of either of clause 1 or clause 2, wherein the first routing circuitry is disposed adjacent to the second routing circuitry.

Clause 4. The transceiver integrated circuit of any of clauses 1-3, wherein the cross-over circuitry is responsive to the at least one first feedback control signal to communicatively couple a first point of a first transmission line of the first routing circuitry to a second point of a second transmission line of the second routing circuitry, the first point of the first transmission line being separated from the second point of the second transmission line by less than 1 mm.

Clause 5. The transceiver integrated circuit of any of clauses 1-4, wherein the cross-over circuitry comprises a first switch and a second switch, the first switch being responsive to a first feedback control signal to communicatively couple a first point of a first transmission line of the first routing circuitry to a second point of a second transmission line of the second routing circuitry, and the second switch being responsive to a second feedback control signal to communicatively couple a third point of the second transmission line of the second routing circuitry to a fourth point of the first transmission line of the first routing circuitry.

Clause 6. The transceiver integrated circuit of any of clauses 1-5, wherein the first transceiver subcircuit includes:
a plurality of first phase shifters each communicatively coupled to a first power-amplifier input of a respective one of the plurality of first power amplifiers;
a plurality of first low-noise amplifiers each including a respective low-noise-amplifier input that is communicatively coupled to a respective one of the plurality of first radio frequency input/output ports;
a plurality of second phase shifters each communicatively coupled to a first low-noise-amplifier output of a respective one of the plurality of first low-noise amplifiers;
a mission-mode mixer at least selectively communicatively coupled to outputs of the plurality of first low-noise amplifiers via the first routing circuitry; and
feedback circuitry that is responsive to at least one second feedback control signal to communicatively couple at least one respective first power-amplifier output of the plurality of first power amplifiers to the mission-mode mixer.

Clause 7. The transceiver integrated circuit of any of clauses 1-5, wherein the first transceiver subcircuit includes:
a plurality of first phase shifters each communicatively coupled to a first power-amplifier input of a respective one of the plurality of first power amplifiers;
a plurality of first low-noise amplifiers each including a respective low-noise-amplifier input that is communicatively coupled to a respective one of the plurality of first radio frequency input/output ports;
a plurality of second phase shifters each communicatively coupled to a first low-noise-amplifier output of a respective one of the plurality of first low-noise amplifiers;
a mission-mode mixer at least selectively communicatively coupled to outputs of the plurality of first low-noise amplifiers via the first routing circuitry;
a feedback mixer separate from the mission-mode mixer and at least selectively communicatively coupled to outputs of at least a portion of the plurality of first low-noise amplifiers via the first routing circuitry; and
feedback circuitry that is responsive to at least one second feedback control signal to communicatively couple at least one respective first power-amplifier output of the plurality of first power amplifiers to the feedback mixer.

Clause 8. The transceiver integrated circuit of clause 7, wherein the feedback mixer is a MIMO mixer (multiple-input, multiple-output mixer).

Clause 9. The transceiver integrated circuit of any of clauses 1-8, further comprising:
an oscillator; and
a transmission mixer communicatively coupled to the oscillator, and selectively communicatively coupled to the first intermediate frequency input/output port and to the second intermediate frequency input/output port via the cross-over circuitry, the transmission mixer being responsive to reception of an oscillator signal from the oscillator and reception of an intermediate frequency transmit signal to multiply the intermediate frequency transmit signal by the oscillator signal, the intermediate frequency transmit signal being either a first intermediate frequency transmit signal from the first intermediate frequency input/output port or a second intermediate frequency transmit signal from the second intermediate frequency input/output port.

Clause 10. A method for use in self-testing a transceiver integrated circuit, the method comprising:
receiving a test signal, having a first intermediate frequency, at a first intermediate frequency input/output port associated with a first transceiver subcircuit of the transceiver integrated circuit;
directing the test signal to a second transceiver subcircuit of the transceiver integrated circuit;
upconverting the test signal to have a radio frequency;
amplifying the test signal by a power amplifier, of the second transceiver subcircuit, to provide an amplified test signal;
coupling at least a portion of the amplified test signal as a feedback signal;
downconverting the feedback signal to a second intermediate frequency; and
directing the feedback signal to a second intermediate frequency input/output port associated with the second transceiver subcircuit.

Clause 11. The method of clause 10, wherein downcoverting the feedback signal comprises mixing the feedback signal with a local oscillator signal in a mission-mode mixer of the second transceiver subcircuit.

Clause 12. The method of either of clause 10 or clause 11, wherein downcoverting the feedback signal comprises mixing the feedback signal with a local oscillator signal in a multi-input/multiple-output mixer of the second transceiver subcircuit, the multi-input/multiple-output mixer being separate from a mission-mode mixer of the second transceiver subcircuit.

Clause 13. The method of clause 12, further comprising filtering the feedback signal output by the multi-input/multiple-output mixer using a first frequency-based filter to pass signals below a first frequency threshold and to reject signals above a second frequency threshold, wherein a second frequency-based filter is communicatively coupled to an output of the mission-mode mixer and is configured to reject signals below a third frequency threshold and to pass signals above a fourth frequency threshold.

Clause 14. A transceiver integrated circuit comprising:
means for receiving a test signal, having a first intermediate frequency, at a first intermediate frequency input/output port associated with a first transceiver subcircuit of the transceiver integrated circuit;
means for directing the test signal to a second transceiver subcircuit of the transceiver integrated circuit;
means for upconverting the test signal to have a radio frequency;
means for amplifying the test signal to provide an amplified test signal;
means for coupling at least a portion of the amplified test signal as a feedback signal;
means for downconverting the feedback signal to a second intermediate frequency; and
means for directing the feedback signal to a second intermediate frequency input/output port associated with the second transceiver subcircuit.

Clause 15. The transceiver integrated circuit of clause 14, wherein the means for downcoverting the feedback signal comprise a mission-mode mixer of the second transceiver subcircuit configured to mix the feedback signal with a local oscillator signal.

Clause 16. The transceiver integrated circuit of either clause 14 or clause 15, wherein the means for downcoverting the feedback signal comprise a multi-input/multiple-output mixer of the second transceiver subcircuit configured to mix the feedback signal with a local oscillator signal, the multi-input/multiple-output mixer being separate from a mission-mode mixer of the second transceiver subcircuit.

Clause 17. The transceiver integrated circuit of clause 16, further comprising:
means for filtering the feedback signal output by the multi-input/multiple-output mixer to pass signals below a first frequency threshold and to reject signals above a second frequency threshold; and
means for filtering an output of the mission-mode mixer to reject signals below a third frequency threshold and to pass signals above a fourth frequency threshold.

Clause 18. A transceiver integrated circuit comprising:
a first intermediate frequency input/output port;
a second intermediate frequency input/output port;
a first transceiver subcircuit including:
   a plurality of first radio frequency input/output ports;
   a plurality of first power amplifiers each including a respective first power-amplifier output that is communicatively coupled to a respective one of the plurality of first radio frequency input/output ports; and
   a plurality of first low-noise amplifiers each including a respective low-noise-amplifier input that is selectively communicatively coupled to a respective one of the plurality of first radio frequency input/output ports;
first routing circuitry that is responsive to at least one first routing control signal to communicatively couple the first intermediate frequency input/output port to the first transceiver subcircuit;
a mission-mode mixer at least selectively communicatively coupled to outputs of the plurality of first low-noise amplifiers via the first routing circuitry;
a second transceiver subcircuit including:
   a plurality of second radio frequency input/output ports; and
   a plurality of second power amplifiers each including a respective second power-amplifier output that is communicatively coupled to a respective one of the plurality of second radio frequency input/output ports;
second routing circuitry that is responsive to at least one second routing control signal to communicatively couple the second intermediate frequency input/output port to the second transceiver subcircuit; and
feedback circuitry that is responsive to at least one feedback control signal to communicatively couple at least one respective first power-amplifier output of the plurality of first power amplifiers to the mission-mode mixer.

Clause 19. The transceiver integrated circuit of clause 18, further comprising cross-over circuitry that is responsive to at least one first feedback control signal to communicatively couple the first intermediate frequency input/output port to the second routing circuitry to provide a first transmit signal from the first intermediate frequency input/output port to the second transceiver subcircuit, and to communicatively couple the second intermediate frequency input/output port to the first routing circuitry to provide a second transmit signal from the second intermediate frequency input/output port to the first transceiver subcircuit.

Clause 20. The transceiver integrated circuit of clause 19, wherein:
the first transceiver subcircuit comprises a plurality of first radio frequency input/output ports disposed nearer a first edge of the transceiver integrated circuit than the plurality of first power amplifiers;
the first routing circuitry is disposed further from the first edge of the transceiver integrated circuit than the plurality of first power amplifiers;
the second transceiver subcircuit comprises a plurality of second radio frequency input/output ports disposed nearer a second edge of the transceiver integrated circuit than the plurality of second power amplifiers; and
the second routing circuitry is disposed further from the second edge of the transceiver integrated circuit than the plurality of second power amplifiers;
wherein the first edge is separate from and substantially parallel to the second edge.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, the components may be directly or indirectly connected to enable signal transfer between the components. Communicative coupling includes selective communicative coupling, e.g., components each being coupled to a switch that may be controlled to open to isolate the components or be controlled to close to complete (at least a portion of) a connection between the components.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A transceiver integrated circuit comprising:
a first intermediate frequency input/output port;
a second intermediate frequency input/output port;
a first transceiver subcircuit including:
a plurality of first radio frequency input/output ports; and
a plurality of first power amplifiers each including a respective first power-amplifier output that is communicatively coupled to a respective one of the plurality of first radio frequency input/output ports;
first routing circuitry that is responsive to at least one first routing control signal to communicatively couple the first intermediate frequency input/output port to the first transceiver subcircuit;
a second transceiver subcircuit including:
a plurality of second radio frequency input/output ports; and
a plurality of second power amplifiers each including a respective second power-amplifier output that is communicatively coupled to a respective one of the plurality of second radio frequency input/output ports;
second routing circuitry that is responsive to at least one second routing control signal to communicatively couple the second intermediate frequency input/output port to the second transceiver subcircuit; and
cross-over circuitry that is responsive to at least one first feedback control signal to communicatively couple the first intermediate frequency input/output port to the second routing circuitry to provide a first transmit signal from the first intermediate frequency input/output port to the second transceiver subcircuit.

2. The transceiver integrated circuit of claim 1, wherein:
the plurality of first radio frequency input/output ports are disposed nearer a first edge of the transceiver integrated circuit than the plurality of first power amplifiers;
the first routing circuitry is disposed further from the first edge of the transceiver integrated circuit than the plurality of first power amplifiers;
the plurality of second radio frequency input/output ports are disposed nearer a second edge of the transceiver integrated circuit than the plurality of second power amplifiers; and
the second routing circuitry is disposed further from the second edge of the transceiver integrated circuit than the plurality of second power amplifiers.

3. The transceiver integrated circuit of claim 1, wherein the first routing circuitry is disposed adjacent to the second routing circuitry.

4. The transceiver integrated circuit of claim 1, wherein the cross-over circuitry is responsive to the at least one first feedback control signal to communicatively couple a first point of a first transmission line of the first routing circuitry to a second point of a second transmission line of the second routing circuitry, the first point of the first transmission line being separated from the second point of the second transmission line by less than 1 mm.

5. The transceiver integrated circuit of claim 1, wherein the cross-over circuitry comprises a first switch and a second switch, the first switch being responsive to a first feedback control signal to communicatively couple a first point of a first transmission line of the first routing circuitry to a second point of a second transmission line of the second routing circuitry, and the second switch being responsive to a second feedback control signal to communicatively couple a third point of the second transmission line of the second routing circuitry to a fourth point of the first transmission line of the first routing circuitry.

6. The transceiver integrated circuit of claim 1, wherein the first transceiver subcircuit includes:
a plurality of first phase shifters each communicatively coupled to a first power-amplifier input of a respective one of the plurality of first power amplifiers;
a plurality of first low-noise amplifiers each including a respective low-noise-amplifier input that is communicatively coupled to a respective one of the plurality of first radio frequency input/output ports;
a plurality of second phase shifters each communicatively coupled to a first low-noise-amplifier output of a respective one of the plurality of first low-noise amplifiers;
a mission-mode mixer at least selectively communicatively coupled to outputs of the plurality of first low-noise amplifiers via the first routing circuitry; and
feedback circuitry that is responsive to at least one second feedback control signal to communicatively couple at least one respective first power-amplifier output of the plurality of first power amplifiers to the mission-mode mixer.

7. The transceiver integrated circuit of claim 1, wherein the first transceiver subcircuit includes:
a plurality of first phase shifters each communicatively coupled to a first power-amplifier input of a respective one of the plurality of first power amplifiers;
a plurality of first low-noise amplifiers each including a respective low-noise-amplifier input that is communicatively coupled to a respective one of the plurality of first radio frequency input/output ports;
a plurality of second phase shifters each communicatively coupled to a first low-noise-amplifier output of a respective one of the plurality of first low-noise amplifiers;
a mission-mode mixer at least selectively communicatively coupled to outputs of the plurality of first low-noise amplifiers via the first routing circuitry;
a feedback mixer separate from the mission-mode mixer and at least selectively communicatively coupled to outputs of at least a portion of the plurality of first low-noise amplifiers via the first routing circuitry; and
feedback circuitry that is responsive to at least one second feedback control signal to communicatively couple at least one respective first power-amplifier output of the plurality of first power amplifiers to the feedback mixer.

8. The transceiver integrated circuit of claim 7, wherein the feedback mixer is a MIMO mixer (multiple-input, multiple-output mixer).

9. The transceiver integrated circuit of claim 1, further comprising:
an oscillator; and
a transmission mixer communicatively coupled to the oscillator, and selectively communicatively coupled to the first intermediate frequency input/output port and to the second intermediate frequency input/output port via the cross-over circuitry, the transmission mixer being responsive to reception of an oscillator signal from the oscillator and reception of an intermediate frequency transmit signal to multiply the intermediate frequency transmit signal by the oscillator signal, the intermediate frequency transmit signal being either a first intermediate frequency transmit signal from the first intermediate frequency input/output port or a second intermediate frequency transmit signal from the second intermediate frequency input/output port.

10. A method for use in self-testing a transceiver integrated circuit, the method comprising:
receiving a test signal, having a first intermediate frequency, at a first intermediate frequency input/output port associated with a first transceiver subcircuit of the transceiver integrated circuit;
directing the test signal to a second transceiver subcircuit of the transceiver integrated circuit;
upconverting the test signal to have a radio frequency;
amplifying the test signal by a power amplifier, of the second transceiver subcircuit, to provide an amplified test signal;
coupling at least a portion of the amplified test signal as a feedback signal;
downconverting the feedback signal to a second intermediate frequency; and
directing the feedback signal to a second intermediate frequency input/output port associated with the second transceiver subcircuit.

11. The method of claim 10, wherein downcoverting the feedback signal comprises mixing the feedback signal with a local oscillator signal in a mission-mode mixer of the second transceiver subcircuit.

12. The method of claim 10, wherein downcoverting the feedback signal comprises mixing the feedback signal with a local oscillator signal in a multi-input/multiple-output mixer of the second transceiver subcircuit, the multi-input/multiple-output mixer being separate from a mission-mode mixer of the second transceiver subcircuit.

13. The method of claim 12, further comprising filtering the feedback signal output by the multi-input/multiple-output mixer using a first frequency-based filter to pass signals below a first frequency threshold and to reject signals above a second frequency threshold, wherein a second frequency-based filter is communicatively coupled to an output of the mission-mode mixer and is configured to reject signals below a third frequency threshold and to pass signals above a fourth frequency threshold.

14. A transceiver integrated circuit comprising:
means for receiving a test signal, having a first intermediate frequency, at a first intermediate frequency input/output port associated with a first transceiver subcircuit of the transceiver integrated circuit;
means for directing the test signal to a second transceiver subcircuit of the transceiver integrated circuit;
means for upconverting the test signal to have a radio frequency;
means for amplifying the test signal to provide an amplified test signal;
means for coupling at least a portion of the amplified test signal as a feedback signal;
means for downconverting the feedback signal to a second intermediate frequency; and
means for directing the feedback signal to a second intermediate frequency input/output port associated with the second transceiver subcircuit.

15. The transceiver integrated circuit of claim 14, wherein the means for downcoverting the feedback signal comprise a mission-mode mixer of the second transceiver subcircuit configured to mix the feedback signal with a local oscillator signal, and wherein the first intermediate frequency is the same as the second intermediate frequency.

16. The transceiver integrated circuit of claim 14, wherein the means for downcoverting the feedback signal comprise a multi-input/multiple-output mixer of the second transceiver subcircuit configured to mix the feedback signal with a local oscillator signal, the multi-input/multiple-output mixer being separate from a mission-mode mixer of the second transceiver subcircuit, wherein the first intermediate frequency is different from the second intermediate frequency.

17. The transceiver integrated circuit of claim 16, further comprising:
means for filtering the feedback signal output by the multi-input/multiple-output mixer to pass signals below a first frequency threshold and to reject signals above a second frequency threshold; and
means for filtering an output of the mission-mode mixer to reject signals below a third frequency threshold and to pass signals above a fourth frequency threshold.

18. A transceiver integrated circuit comprising:
a first intermediate frequency input/output port;
a second intermediate frequency input/output port;
a first transceiver subcircuit including:
a plurality of first radio frequency input/output ports;
a plurality of first power amplifiers each including a respective first power-amplifier output that is communicatively coupled to a respective one of the plurality of first radio frequency input/output ports; and
a plurality of first low-noise amplifiers each including a respective low-noise-amplifier input that is selectively communicatively coupled to a respective one of the plurality of first radio frequency input/output ports;
first routing circuitry that is responsive to at least one first routing control signal to communicatively couple the first intermediate frequency input/output port to the first transceiver subcircuit;
a mission-mode mixer at least selectively communicatively coupled to outputs of the plurality of first low-noise amplifiers via the first routing circuitry;
a second transceiver subcircuit including:
a plurality of second radio frequency input/output ports; and
a plurality of second power amplifiers each including a respective second power-amplifier output that is communicatively coupled to a respective one of the plurality of second radio frequency input/output ports;
second routing circuitry that is responsive to at least one second routing control signal to communicatively couple the second intermediate frequency input/output port to the second transceiver subcircuit; and
feedback circuitry that is responsive to at least one feedback control signal to communicatively couple at least one respective first power-amplifier output of the plurality of first power amplifiers to the mission-mode mixer.

19. The transceiver integrated circuit of claim 18, further comprising cross-over circuitry that is responsive to at least one first feedback control signal to communicatively couple the first intermediate frequency input/output port to the second routing circuitry to provide a first transmit signal from the first intermediate frequency input/output port to the second transceiver subcircuit, and to communicatively couple the second intermediate frequency input/output port to the first routing circuitry to provide a second transmit signal from the second intermediate frequency input/output port to the first transceiver subcircuit.

20. The transceiver integrated circuit of claim 19, wherein:
the plurality of first radio frequency input/output ports are disposed nearer a first edge of the transceiver integrated circuit than the plurality of first power amplifiers;
the first routing circuitry is disposed further from the first edge of the transceiver integrated circuit than the plurality of first power amplifiers;
the plurality of second radio frequency input/output ports are disposed nearer a second edge of the transceiver integrated circuit than the plurality of second power amplifiers; and
the second routing circuitry is disposed further from the second edge of the transceiver integrated circuit than the plurality of second power amplifiers;
wherein the first edge is separate from and substantially parallel to the second edge.
